(19) United States
(12) Patent Application Publication
(10) Pub. No.: US 2025/0037261 A1
(43) Pub. Date: Jan. 30, 2025

(54) HIGH-QUALITY WIDE-SPECTRUM DATA BY GENERATIVE AI

(71) Applicant: Orbotech Ltd., Yavne (IL)

(72) Inventor: Hagit Schechter, Mazkeret Batya (IL)

(21) Appl. No.: 18/776,530

(22) Filed: Jul. 18, 2024

Related U.S. Application Data
(60) Provisional application No. 63/529,156, filed on Jul. 27, 2023.

(51) Int. Cl. G06T 7/00; G06V 10/764; G06V 10/774; G06V 10/82; G06V 10/94

(52) U.S. Cl. CPC G06T 7/0004; G06V 10/764; G06V 10/774; G06V 10/945; G06T 2207/20081; G06T 2207/20084; G06T 2207/30148; G06T 2207/30164; G06V 10/82

(57) ABSTRACT

A system includes a light source configured to generate a beam of light, a stage configured to hold a workpiece in the path of the beam of light, a detector configured to capture an image of the workpiece based on the beam of light reflected from the workpiece, and a processor in electronic communication with the detector. The processor is configured to inspect the image of the workpiece received from the detector using an artificial intelligence (AI) inference model that is trained using a combined dataset of manually tagged data and AI-tagged data, and the AI inference model is stored on an electronic data storage unit that is in electronic communication with the processor.

### CROSS-REFERENCE TO RELATED APPLICATIONS

This application claims priority to the provisional patent application filed Jul. 27, 2023, and assigned U.S. App. No. 63/529,156, the disclosure of which is hereby incorporated by reference.

### FIELD OF THE DISCLOSURE

This disclosure relates to semiconductor inspection and, more particularly, to a semiconductor defect detection using artificial intelligence (AI) models.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it determines the return-on-investment for a semiconductor manufacturer.

Fabricating semiconductor devices, such as logic and memory devices, typically includes processing a workpiece, such as a semiconductor wafer, using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etch, deposition, and ion implantation. An arrangement of multiple semiconductor devices fabricated on a single semiconductor wafer may be separated into individual semiconductor devices.

Inspection processes are used at various steps during semiconductor manufacturing to detect defects on wafers to promote higher yield in the manufacturing process and, thus, higher profits. Inspection has always been an important part of fabricating semiconductor devices such as integrated circuits (ICs). However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary because even relatively small defects may cause unwanted aberrations in the semiconductor devices.

As design rules shrink, however, semiconductor manufacturing processes may be operating closer to the limitation on the performance capability of the processes. In addition, smaller defects can have an impact on the electrical parameters of the device as the design rules shrink, which drives more sensitive inspections. As design rules shrink, the population of potentially yield-relevant defects detected by inspection grows dramatically, and the population of nuisance defects detected by inspection also increases dramatically. Therefore, more defects may be detected on the wafers, and correcting the processes to eliminate all of the defects may be difficult and expensive. Determining which of the defects actually have an effect on the electrical parameters of the devices and the yield may allow process control methods to be focused on those defects while largely ignoring others. Furthermore, at smaller design rules, process-induced failures, in some cases, tend to be systematic. That is, process-induced failures tend to fail at predetermined design patterns often repeated many times within the design. Elimination of spatially-systematic, electrically-relevant defects can have an impact on yield.

Some inspection systems rely on computer vision algorithms to identify suspected defects in a sample, which must be manually reviewed for confirmation. While these algorithms are tuned for prevention of missed critical defects, this generally leads to tagging non-critical defects or samples with no defects at all, which increases time required for manual review and delays production. These algorithms are also generally designed for specific types of defects in a particular recipe and are not easily adaptable to recipe changes.

Artificial Intelligence (AI) systems (such as deep neural networks (DNNs) or other types of AI models) can be used to identify and classify defects in inspection images. However, these AI models rely on massive amounts of data to train the system to automatically classify new and unseen examples as a defect or non-defect in a successful and reliable manner. While new data samples can be readily gathered during inspection, a manual tagging process is used to classify the samples for training of the model. Such manual tagging processes are time consuming and prone to human error and subjectivity. Any compromise on the tagged dataset size or consistency reduces the reliability of the AI model detection results. Furthermore, the AI model can only be kept up-to-date with recipe changes with consistent manual tagging of new samples. In some instances, only a small set of examples for a specific defect type are available, and it is difficult for the AI model to form sufficiently reliable predictions on new samples based on this small amount of training data.

Therefore, what is needed is an improved defect detection process with improved reliability and efficiency.

### BRIEF SUMMARY OF THE DISCLOSURE

An embodiment of the present disclosure provides a system. The system may comprise a light source configured to generate a beam of light, a stage configured to hold a workpiece in a path of the beam of light, a detector configured to capture an image of the workpiece based on the beam of light reflected from the workpiece, a processor in electronic communication with the detector, and an electronic data storage unit in electronic communication with the processor. The processor may be configured to inspect the image of the workpiece received from the detector using an artificial intelligence (AI) inference model that is trained using a combined dataset of manually tagged data and AI-tagged data, and the AI inference model may be stored on the electronic data storage unit.

In some embodiments, the processor may be further configured to receive manually tagged data, generate AI-tagged data based on the manually tagged data using an AI generator model, combine the manually tagged data and the AI-tagged data to produce the combined dataset, and train the AI inference model using the combined dataset. The AI generator model may be stored on the electronic data storage unit.

In some embodiments, the manually tagged data may comprise data having a timestamp within a defined time period.

In some embodiments, the processor may be further configured to determine a subset of the manually tagged data, generate additional AI-tagged data based on the subset of the manually tagged data using the AI generator model, combine the combined dataset and the additional AI-tagged data to produce an extended training dataset, and retrain the AI inference model using the extended training dataset.

In some embodiments, the processor may be configured to determine the subset of the manually tagged data according to a type of defect in the workpiece, in response to receiving a user selection of the type of defect in the workpiece.

In some embodiments, the processor may be further configured to determine the subset of the manually tagged data according to the type of defect in the workpiece having an accuracy that is less than an accuracy threshold, in response to receiving a user selection of the accuracy threshold.

In some embodiments, the manually tagged data and the AI-tagged data may be tagged according to a binary classification based on presence of a defect in the workpiece.

In some embodiments, the manually tagged data and the AI-tagged data may be tagged according to a plural classification based on identification of one of a plurality of types of defects in the workpiece.

Another embodiment of the present disclosure provides a method. The method may comprise receiving, at a processor, an image of a workpiece, and inspecting the image using an artificial intelligence (AI) inference model that is trained using a combined dataset of manually tagged data and AI-generated data.

In some embodiments, the method may further comprise receiving manually tagged data, generating AI-tagged data based on the manually tagged data using an AI generator model, combining the manually tagged data and the AI-tagged data to produce the combined dataset, and training the AI inference model using the combined dataset.

In some embodiments, the manually tagged data may comprise data having a timestamp within a defined time period.

In some embodiments, the method may further comprise determining a subset of the manually tagged data, generating additional AI-tagged data based on the subset of the manually tagged data using the AI generator model, combining the combined dataset and the additional AI-tagged data to produce an extended training dataset, and retraining the AI inference model using the extended training dataset.

In some embodiments, determining the subset of the manually tagged data may comprise receiving a user selection of a type of defect in the workpiece, and determining the subset of the manually tagged data according to the type of defect in the workpiece.

In some embodiments, determining the subset of the manually tagged data may further comprise receiving a user selection of an accuracy threshold, and determining the subset of the manually tagged data according to the type of defect in the workpiece having an accuracy that is less than the accuracy threshold.

Another embodiment of the present disclosure provides a non-transitory computer-readable storage medium comprising one or more programs. When executed by a processor, the one or more programs may cause the processor to receive an image of a workpiece and inspect the image using an artificial intelligence (AI) inference model that is trained using a combined dataset of manually tagged data and AI-generated data.

In some embodiments, the processor may be further caused to receive manually tagged data, generate AI-tagged data based on the manually tagged data using an AI generator model, combine the manually tagged data and the AI-tagged data to produce the combined dataset, and train the AI inference model using the combined dataset.

In some embodiments, the manually tagged data may comprise data having a timestamp within a defined time period.

In some embodiments, the processor may be further caused to determine a subset of the manually tagged data, generate additional AI-tagged data based on the subset of the manually tagged data using the AI generator model, combine the manually tagged data and the additional AI-tagged data to produce an extended training dataset, and retrain the AI inference model using the extended training dataset.

In some embodiments, the processor may be further caused to receive a user selection of a type of defect in the workpiece and determine the subset of the manually tagged data according to the type of defect in the workpiece.

In some embodiments, the processor may be further caused to receive a user selection of an accuracy threshold and determine the subset of the manually tagged data according to the type of defect in the workpiece having an accuracy that is less than the accuracy threshold.

### DESCRIPTION OF THE DRAWINGS

For a fuller understanding of the nature and objects of the disclosure, reference should be made to the following detailed description taken in conjunction with the accompanying drawings, in which:

FIG. 1 is a flowchart of a method according to an embodiment of the present disclosure;

FIG. 2 is a flowchart of a method according to another embodiment of the present disclosure;

FIG. 3 is a flowchart of a method according to another embodiment of the present disclosure;

FIG. 4 is a diagram of a system according to an embodiment of the present disclosure;

FIG. 5 is a data flow diagram according to an embodiment of the present disclosure;

FIG. 6 is a data flow diagram according to another embodiment of the present disclosure;

FIG. 7 is a data flow diagram according to another embodiment of the present disclosure; and

FIG. 8 is a data flow diagram according to another embodiment of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

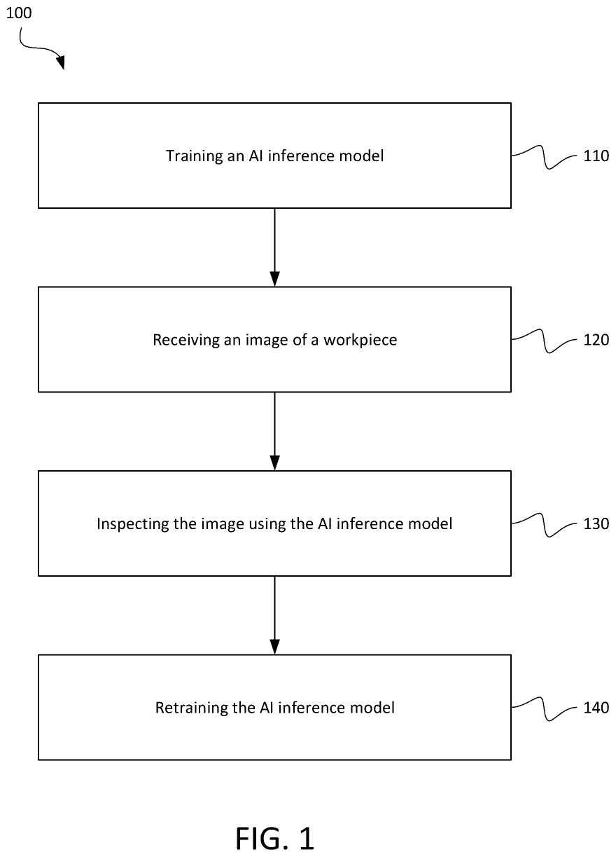

An embodiment of the present disclosure provides a method 100, as shown in FIG. 1. The method 100 may comprise the following steps.

At step 120, a processor receives an image of a workpiece. For example, the processor may be configured to receive the image from a detector of an optical inspection system. The workpiece may be, for example, a semiconductor wafer, substrate, printed circuit board (PCB), integrated circuit (IC) chips, glass for flat panel displays (FPD), or other types of workpieces.

At step 130, the processor inspects the image using an artificial intelligence (AI) inference model. The AI inference model may be trained using a combined dataset of manually tagged data and AI-generated data. By inspecting the image, the processor may be configured to identify defects in the workpiece. For example, the processor may be configured to classify the image of the workpiece according to a binary classification (e.g., identify presence of a defect in the workpiece or no defect being present) or a plural classification (e.g., identify presence of one of a plurality of types of defects in the workpiece or no defect being present). In some embodiments, the types of defects found in the workpiece may include one or more of an electrical short, open connection, nick, dish down, protrusion, island, missing hole, or other types of defects found in various types of workpieces. The processor may be further configured to identify a location of a defect identified in the workpiece.

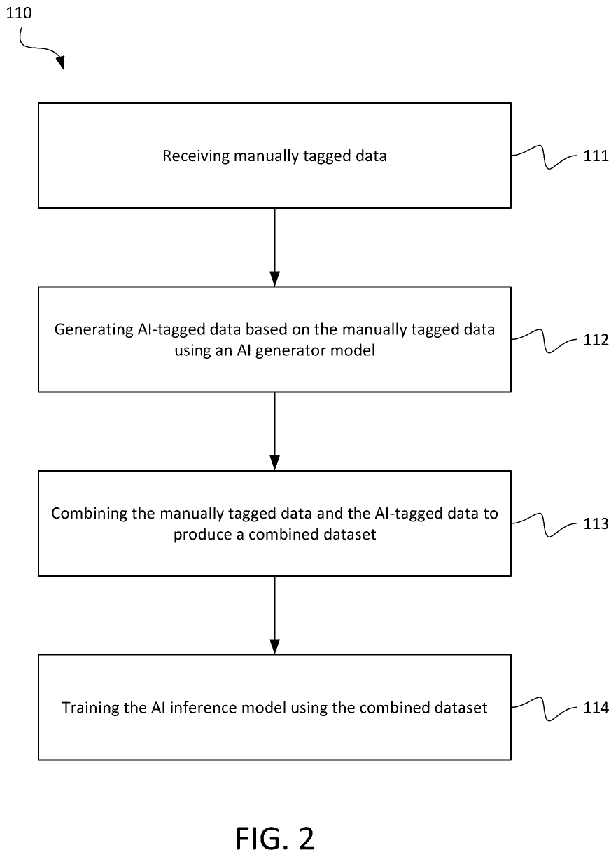

In some embodiments, the method 100 may further comprise step 110 prior to step 120. At step 110, the AI inference model is trained. As shown in FIG. 2, step 110 may comprise the following steps.

At step 111, the processor receives manually tagged data. The manually tagged data may comprise a plurality of images of workpieces captured by an optical inspection system. The plurality of images of workpieces have been manually tagged by a human operator to identify the presence of defects or no defects, the type of defect, and/or a location of the defect on the workpiece. In some embodiments, the manually tagged data may comprise an entire set of stored data. Alternatively, the manually tagged data may comprise a portion of the set of stored data. For example, each piece of manually tagged data may comprise a timestamp corresponding to the time when the image of the workpiece was captured. The manually tagged data may comprise the portion of the set of stored data having a timestamp within a defined time period. For example, the defined time period may correspond to a particular day, week, month or year, and the timestamp may be a specific date, hour, minute, and/or second of when the image of the workpiece was captured. The time period may be predefined or defined in response to a user selection. Accordingly, the manually tagged data received by the processor may be limited to times of a particular manufacturing recipe, production cycle, or most recent data. The amount of manually tagged data may depend on the variety of the data and the defects. For example, more manually tagged data may be collected where the AI inference model is to be trained to identify defects in various scenarios, while a narrowly tailored AI inference model may be trained with a smaller dataset. In some embodiments, the manually tagged data may comprise a few thousands samples.

At step 112, the processor generates AI-tagged data based on the manually tagged data using an AI generator model. The AI generator model may be a deep learning model, such as a deep neural network (DNN), convolutional neural network (CNN), or other type of neural network or generative AI algorithm. The AI-tagged data may be AI-generated images of workpieces similar to those of the plurality of images of workpieces of the manually tagged data and may identify the presence of defects or no defects, the type of defect, and/or a location of the defect on the workpiece. For example, the AI generator model may learn the geometry and patterns surrounding each type of defect of the manually tagged data and can produce new AI-tagged images having each type of defect. In this way, new and unique AI-generated images can be produced from the manually tagged data.

At step 113, the manually tagged data and the AI-tagged data are combined to produce a combined dataset. In other words, the AI-tagged data may be used to obtain a corpus of training data that is larger than the manually tagged data alone, such that human tagging is only used for a portion of the corpus of training data. Accordingly, the time for the manually tagging process may be reduced, and the impact of human error and subjectivity can be avoided.

At step 114, the AI inference model is trained using the combined dataset. In particular, the AI inference model is trained using both the manually tagged data and the AI-tagged data. Since the combined dataset is a larger corpus of training data compared to the manually tagged data alone, the AI inference model may be more robust in the inspection of defects in a workpiece. For example, while the manually tagged data may only include a limited number of images of a workpiece with a certain type of defect, the AI generator model may be used to produce AI-tagged data including additional images with the same type of defect. Accordingly, the AI inference model may be able to more accurately identify different types of defects with minimal manually tagged data.

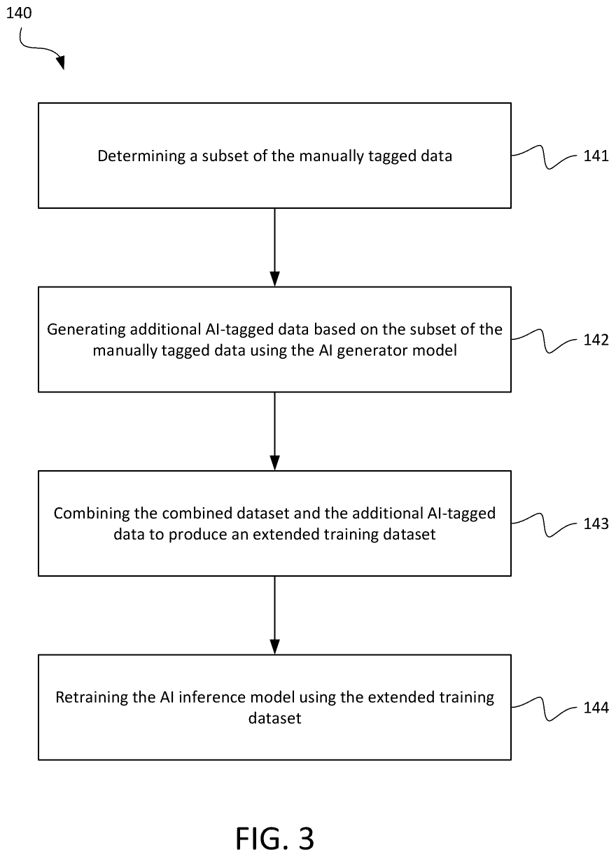

In some embodiments, the method 100 may comprise step 140 after step 130. At step 140, the AI inference model is retrained. As shown in FIG. 3, step 140 may comprise the following steps.

At step 141, the processor determines a subset of the manually tagged data. For example, after using the AI inference model to inspect images, the accuracy of identification of defects in the workpiece may vary for particular types of defects or circumstances (e.g., location of the defect in the image). In addition, the production recipe may change, which can reduce the accuracy of identification of defects in the workpiece, as the workpiece and the defects that can be present in the workpiece change. Accordingly, the AI inference model can be retrained to improve accuracy and adapt to new recipes. For example, the subset of the manually tagged data can be selected to improve a particular aspect of the AI inference model. The subset of the manually tagged data may comprise a user selection of specific example images, a specific type of defect in the workpiece, types of defects having an accuracy less than an accuracy threshold. For example, the processor may receive a user selection of a type of defect in the workpiece, and the processor can determine the subset of the manually tagged data according to the type of defect in the workpiece. The processor may further receive a user selection of an accuracy threshold, and the processor can determine the subset of the manually tagged data according to the type of defect in the workpiece having an accuracy that is less than the accuracy threshold. The accuracy of inspection may be an absolute accuracy of the AI inference model in identifying a particular type of defect in the workpiece or a relative accuracy of the AI inference model in identifying a particular type of defect in the workpiece compared to other types of defects. Accordingly, the user can select a specific population of manually tagged data that has a relatively low accuracy to help improve the overall accuracy of the AI inference model.

In some embodiments, the processor may receive additional manually tagged data to retrain the AI inference model. The additional manually tagged data may be, for example, manually tagged images of a workpiece inspected after production recipe changes. The additional manually tagged data may be received in place of, or in addition to, the subset of the manually tagged data determined in step 141.

In some embodiments, the user selection may be a free text field, and the processor may determine the subset of the manually tagged data the corresponds to the input text using a Contrastive Language-Image Pretraining (CLIP) model. The more detailed the input text may be, the easier it may be for the CLIP model to understand and determine the subset of the manually tagged data or generate new samples. For example, an input text may comprise, “sever short at the top left corner,” “deep penetration in the center,” “thin copper line between two circuits in the center,” “a small particle close to a top left corner, not touching any lines,” “a tiny protrusion on the main circuit right after the big pad,” or other type text phrase defining the type of defect and/or the location of the defect in the image.

At step 142, the processor generates additional AI-tagged data based on the subset of manually tagged data using the AI generator model. With the AI generator model is focused on the subset of manually tagged data (rather than the entire set of manually tagged data), the additional AI-tagged data may be focused on, and related to, the particular type of defect or circumstances of the user-selected subset of manually tagged data.

At step 143, the combined dataset and the additional AI-tagged data are combined to produce an extended training dataset. Accordingly, the extended training dataset may be more robust than the combined dataset, as it further includes the additional AI-tagged data that is focused on a particular type of defect or circumstances.

At step 144, the AI inference model is retrained using the extended training dataset. In particular, the AI inference model is trained using both combined dataset (comprising the manually tagged data and the AI-tagged data) and the extended training dataset. With the additional AI-tagged data in the corpus of training data, the AI inference model may be more robust in the inspection of defects in a workpiece. For example, while the combined dataset used to initially train the AI inference model may only include a limited number of images of a workpiece with a certain type of defect, the AI generator model may be used to produce additional AI-tagged data including additional images with the same type of defect. Accordingly, the AI inference model may be retrained to more accurately identify different types of defects with minimal manually tagged data and can be adaptable to recipe changes without a ramp-up training phase of collecting additional manually tagged data.

In some instances, the accuracy of the AI inference model may be determined according to a check process, in which images from the manually tagged dataset and the AI-generated dataset are input into the AI inference model to verify that the output inspection results correspond to their respective tagged classifications. The check process may indicate that the AI inference model is accurate when the predicted classification results of input images from the manually tagged dataset and the AI-tagged dataset match the tags of the manually tagged dataset or the AI-tagged dataset

With the method 100, an improved defect detection process is provided, having improved reliability and efficiency due to the use of AI-tagged data to supplement manually tagged data to train the AI inference model. In addition, the AI inference model can be retrained to maintain accuracy through life-cycle changes by selectively generating additional AI-tagged data to provide improved AI accuracy with reduced labor time related to manual tagging and checks. By reducing the amount of manually tagged data relied on in the inspection process may further improve consistency of inspection results by reducing human error.

Another embodiment of the present disclosure provides an optical inspection system 200, as shown in FIG. 3. The system 200 includes optical based subsystem 201. In general, the optical based subsystem 201 is configured for generating optical based output for a specimen 202 by directing light to (or scanning light over) and detecting light from the specimen 202. In one embodiment, the specimen 202 includes a wafer. The wafer may include any wafer known in the art, such as those used in the method 100. In another embodiment, the specimen 202 includes a reticle. The reticle may include any reticle known in the art.

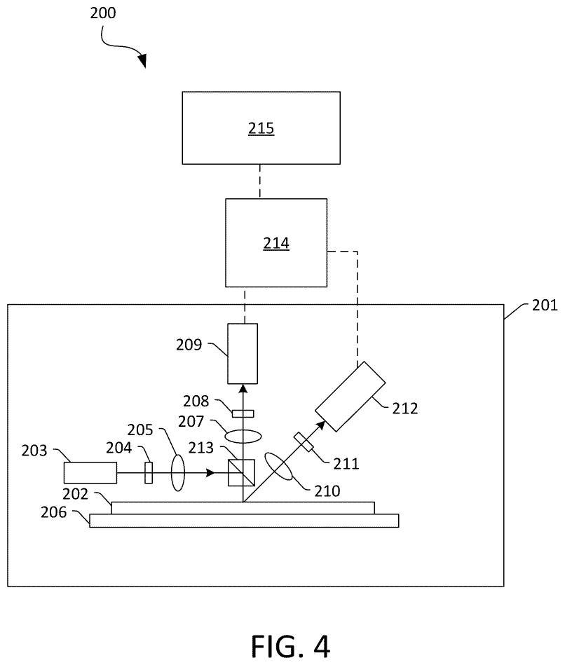

In the embodiment of the system 200 shown in FIG. 4, optical based subsystem 201 includes an illumination subsystem configured to direct light to specimen 202. The illumination subsystem includes at least one light source. For example, as shown in FIG. 4, the illumination subsystem includes light source 203. In one embodiment, the illumination subsystem is configured to direct the light to the specimen 202 at one or more angles of incidence, which may include one or more oblique angles and/or one or more normal angles. For example, as shown in FIG. 4, light from light source 203 is directed through optical element 204 and then lens 205 to specimen 202 at an oblique angle of incidence. The oblique angle of incidence may include any suitable oblique angle of incidence, which may vary depending on, for instance, characteristics of the specimen 202.

The optical based subsystem 201 may be configured to direct the light to the specimen 202 at different angles of incidence at different times. For example, the optical based subsystem 201 may be configured to alter one or more characteristics of one or more elements of the illumination subsystem such that the light can be directed to the specimen 202 at an angle of incidence that is different than that shown in FIG. 4. In one such example, the optical based subsystem 201 may be configured to move light source 203, optical element 204, and lens 205 such that the light is directed to the specimen 202 at a different oblique angle of incidence or a normal (or near normal) angle of incidence.

In some instances, the optical based subsystem 201 may be configured to direct light to the specimen 202 at more than one angle of incidence at the same time. For example, the illumination subsystem may include more than one illumination channel, one of the illumination channels may include light source 203, optical element 204, and lens 205 as shown in FIG. 4 and another of the illumination channels (not shown) may include similar elements, which may be configured differently or the same, or may include at least a light source and possibly one or more other components such as those described further herein. If such light is directed to the specimen at the same time as the other light, one or more characteristics (e.g., wavelength, polarization, etc.) of the light directed to the specimen 202 at different angles of incidence may be different such that light resulting from illumination of the specimen 202 at the different angles of incidence can be discriminated from each other at the detector(s).

In another instance, the illumination subsystem may include only one light source (e.g., light source 203 shown in FIG. 4) and light from the light source may be separated into different optical paths (e.g., based on wavelength, polarization, etc.) by one or more optical elements (not shown) of the illumination subsystem. Light in each of the different optical paths may then be directed to the specimen 202. Multiple illumination channels may be configured to direct light to the specimen 202 at the same time or at different times (e.g., when different illumination channels are used to sequentially illuminate the specimen). In another instance, the same illumination channel may be configured to direct light to the specimen 202 with different characteristics at different times. For example, in some instances, optical element 204 may be configured as a spectral filter and the properties of the spectral filter can be changed in a variety of different ways (e.g., by swapping out the spectral filter) such that different wavelengths of light can be directed to the specimen 202 at different times. The illumination subsystem may have any other suitable configuration known in the art for directing the light having different or the same characteristics to the specimen 202 at different or the same angles of incidence sequentially or simultaneously.

In one embodiment, light source 203 may include a broadband plasma (BBP) source. In this manner, the light generated by the light source 203 and directed to the specimen 202 may include broadband light. However, the light source may include any other suitable light source such as a laser. The laser may include any suitable laser known in the art and may be configured to generate light at any suitable wavelength or wavelengths known in the art. In addition, the laser may be configured to generate light that is monochromatic or nearly-monochromatic. In this manner, the laser may be a narrowband laser. The light source 203 may also include a polychromatic light source that generates light at multiple discrete wavelengths or wavebands.

Light from optical element 204 may be focused onto specimen 202 by lens 205. Although lens 205 is shown in FIG. 4 as a single refractive optical element, it is to be understood that, in practice, lens 205 may include a number of refractive and/or reflective optical elements that in combination focus the light from the optical element to the specimen. The illumination subsystem shown in FIG. 4 and described herein may include any other suitable optical elements (not shown). Examples of such optical elements include, but are not limited to, polarizing component(s), spectral filter(s), spatial filter(s), reflective optical element(s), apodizer(s), beam splitter(s) (such as beam splitter 213), aperture(s), and the like, which may include any such suitable optical elements known in the art. In addition, the optical based subsystem 201 may be configured to alter one or more of the elements of the illumination subsystem based on the type of illumination to be used for generating the optical based output.

The optical based subsystem 201 may also include a scanning subsystem configured to cause the light to be scanned over the specimen 202. For example, the optical based subsystem 201 may include stage 206 on which specimen 202 is disposed during optical based output generation. The scanning subsystem may include any suitable mechanical and/or robotic assembly (that includes stage 206) that can be configured to move the specimen 202 such that the light can be scanned over the specimen 202. In addition, or alternatively, the optical based subsystem 201 may be configured such that one or more optical elements of the optical based subsystem 201 perform some scanning of the light over the specimen 202. The light may be scanned over the specimen 202 in any suitable fashion such as in a serpentine-like path or in a spiral path.

The optical based subsystem 201 further includes one or more detection channels. At least one of the one or more detection channels includes a detector configured to detect light from the specimen 202 due to illumination of the specimen 202 by the subsystem and to generate output responsive to the detected light. For example, the optical based subsystem 201 shown in FIG. 4 includes two detection channels, one formed by collector 207, element 208, and detector 209 and another formed by collector 210, element 211, and detector 212. As shown in FIG. 4, the two detection channels are configured to collect and detect light at different angles of collection. In some instances, both detection channels are configured to detect scattered light, and the detection channels are configured to detect light that is scattered at different angles from the specimen 202. However, one or more of the detection channels may be configured to detect another type of light from the specimen 202 (e.g., reflected light).

As further shown in FIG. 4, both detection channels are shown positioned in the plane of the paper and the illumination subsystem is also shown positioned in the plane of the paper. Therefore, in this embodiment, both detection channels are positioned in (e.g., centered in) the plane of incidence. However, one or more of the detection channels may be positioned out of the plane of incidence. For example, the detection channel formed by collector 210, element 211, and detector 212 may be configured to collect and detect light that is scattered out of the plane of incidence. Therefore, such a detection channel may be commonly referred to as a “side” channel, and such a side channel may be centered in a plane that is substantially perpendicular to the plane of incidence.

Although FIG. 4 shows an embodiment of the optical based subsystem 201 that includes two detection channels, the optical based subsystem 201 may include a different number of detection channels (e.g., only one detection channel or two or more detection channels). In one such instance, the detection channel formed by collector 210, element 211, and detector 212 may form one side channel as described above, and the optical based subsystem 201 may include an additional detection channel (not shown) formed as another side channel that is positioned on the opposite side of the plane of incidence. Therefore, the optical based subsystem 201 may include the detection channel that includes collector 207, element 208, and detector 209 and that is centered in the plane of incidence and configured to collect and detect light at scattering angle(s) that are at or close to normal to the specimen 202 surface. This detection channel may therefore be commonly referred to as a “top” channel, and the optical based subsystem 201 may also include two or more side channels configured as described above. As such, the optical based subsystem 201 may include at least three channels (i.e., one top channel and two side channels), and each of the at least three channels has its own collector, each of which is configured to collect light at different scattering angles than each of the other collectors.

As described further above, each of the detection channels included in the optical based subsystem 201 may be configured to detect scattered light. Therefore, the optical based subsystem 201 shown in FIG. 4 may be configured for dark field (DF) output generation for specimens 202. However, the optical based subsystem 201 may also or alternatively include detection channel(s) that are configured for bright field (BF) output generation for specimens 202. In other words, the optical based subsystem 201 may include at least one detection channel that is configured to detect light specularly reflected from the specimen 202. Therefore, the optical based subsystems 201 described herein may be configured for only DF, only BF, or both DF and BF imaging. Although each of the collectors are shown in FIG. 4 as single refractive optical elements, it is to be understood that each of the collectors may include one or more refractive optical die(s) and/or one or more reflective optical element(s).

The one or more detection channels may include any suitable detectors known in the art. For example, the detectors may include photo-multiplier tubes (PMTs), charge coupled devices (CCDs), time delay integration (TDI) cameras, and any other suitable detectors known in the art. The detectors may also include non-imaging detectors or imaging detectors. In this manner, if the detectors are non-imaging detectors, each of the detectors may be configured to detect certain characteristics of the scattered light such as intensity but may not be configured to detect such characteristics as a function of position within the imaging plane. As such, the output that is generated by each of the detectors included in each of the detection channels of the optical based subsystem may be signals or data, but not image signals or image data. In such instances, a processor such as processor 214 may be configured to generate images of the specimen 202 from the non-imaging output of the detectors. However, in other instances, the detectors may be configured as imaging detectors that are configured to generate imaging signals or image data. Therefore, the optical based subsystem may be configured to generate optical images or other optical based output described herein in a number of ways.

It is noted that FIG. 4 is provided herein to generally illustrate a configuration of an optical based subsystem 201 that may be included in the system embodiments described herein or that may generate optical based output that is used by the system embodiments described herein. The optical based subsystem 201 configuration described herein may be altered to optimize the performance of the optical based subsystem 201 as is normally performed when designing a commercial output acquisition system. In addition, the systems described herein may be implemented using an existing system (e.g., by adding functionality described herein to an existing system). For some such systems, the methods described herein may be provided as optional functionality of the system (e.g., in addition to other functionality of the system). Alternatively, the system described herein may be designed as a completely new system.

The processor 214 may be coupled to the components of the system 200 in any suitable manner (e.g., via one or more transmission media, which may include wired and/or wireless transmission media) such that the processor 214 can receive output. The processor 214 may be configured to perform a number of functions using the output. The system 200 can receive instructions or other information from the processor 214. The processor 214 and/or the electronic data storage unit 215 optionally may be in electronic communication with a wafer inspection tool, a wafer metrology tool, or a wafer review tool (not illustrated) to receive additional information or send instructions. For example, the processor 214 and/or the electronic data storage unit 215 can be in electronic communication with a scanning electron microscope.

The processor 214, other system(s), or other subsystem(s) described herein may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 214 and electronic data storage unit 215 may be disposed in or otherwise part of the system 200 or another device. In an example, the processor 214 and electronic data storage unit 215 may be part of a standalone control unit or in a centralized quality control unit. Multiple processors 214 or electronic data storage units 215 may be used.

The processor 214 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 214 to implement various methods and functions may be stored in readable storage media, such as a memory in the electronic data storage unit 215 or other memory.

If the system 200 includes more than one processor 214, then the different subsystems may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 214 may be configured to perform a number of functions using the output of the system 200 or other output. For instance, the processor 214 may be configured to send the output to an electronic data storage unit 215 or another storage medium. The processor 214 may be configured according to any of the embodiments described herein. The processor 214 also may be configured to perform other functions or additional steps using the output of the system 200 or using images or data from other sources.

Various steps, functions, and/or operations of system 200 and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random access memory, a magnetic or optical disk, a non-volatile memory, a solid state memory, a magnetic tape, and the like. A carrier medium may include a transmission medium such as a wire, cable, or wireless transmission link. For instance, the various steps described throughout the present disclosure may be carried out by a single processor 214 or, alternatively, multiple processors 214. Moreover, different sub-systems of the system 200 may include one or more computing or logic systems. Therefore, the above description should not be interpreted as a limitation on the present disclosure but merely an illustration.

In an instance, the processor 214 may be in electronic communication with the system 200. The processor 214 may be configured to inspect an image of the workpiece (e.g., specimen 202) received from the detector (e.g., detector 209 or detector 212) using an AI inference model to detect defects in the workpiece. In particular, the AI inference model may be trained using a combined dataset comprising manually tagged data and AI-tagged data generated using an AI generator model. By using the AI generator model to generate AI-tagged data, the amount of manually tagged data used for training the AI inference model can be reduced, and the AI inference model can be fine tuned and retrained for robust adaptability to new defects and recipe changes.

An additional embodiment relates to a non-transitory computer-readable medium storing program instructions executable on a controller for performing a computer-implemented method for inspection, as disclosed herein. In particular, as shown in FIG. 4, electronic data storage unit 215 or other storage medium may contain non-transitory computer-readable medium that includes program instructions executable on the processor 214. The computer-implemented method may include any step(s) of any method(s) described herein, including method 100.

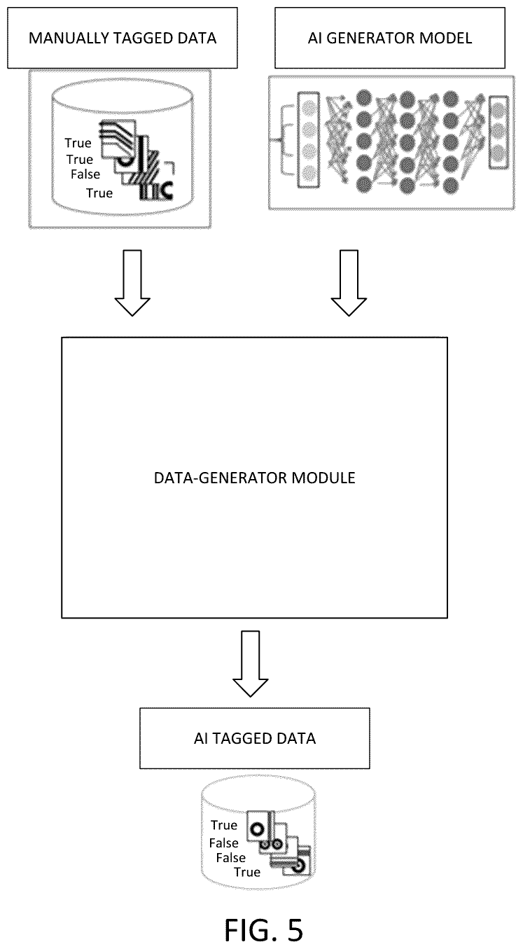

FIG. 5 is a data flow diagram illustrating the computer-implemented process of generating AI-tagged data executed by the by the electronic data storage unit 215 and the processor 214. As shown in FIG. 5, manually tagged data and an AI generator model are input into a data-generator module, which is configured to output AI-tagged data.

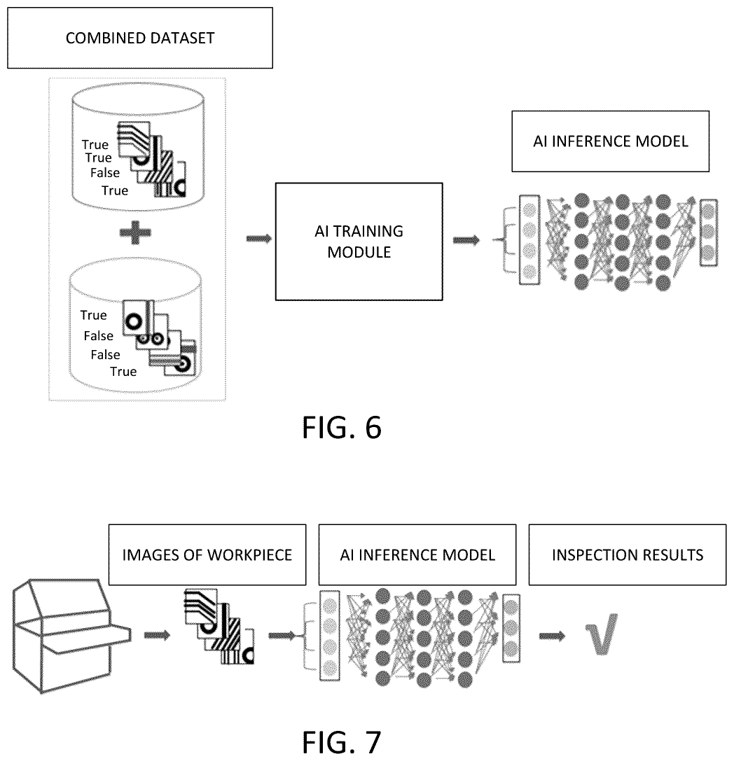

FIG. 6 is a data flow diagram illustrating the computer-implemented process of training the AI inference model executed by the by the electronic data storage unit 215 and the processor 214. As shown in FIG. 6, the combined dataset of manually tagged data and AI-tagged data are input into an AI training module, which is configured to output the AI inference model.

FIG. 7 is a data flow diagram illustrating the computer-implemented process of inspecting images using the AI inference model of a workpiece executed by the by the electronic data storage unit 215 and the processor 214. As shown in FIG. 7, images of the workpiece are input into the AI inference model, which is configured to output inspection results indicating one or more of a presence of a defect in the workpiece, a type of defect in the workpiece, and/or a location of a defect in the workpiece.

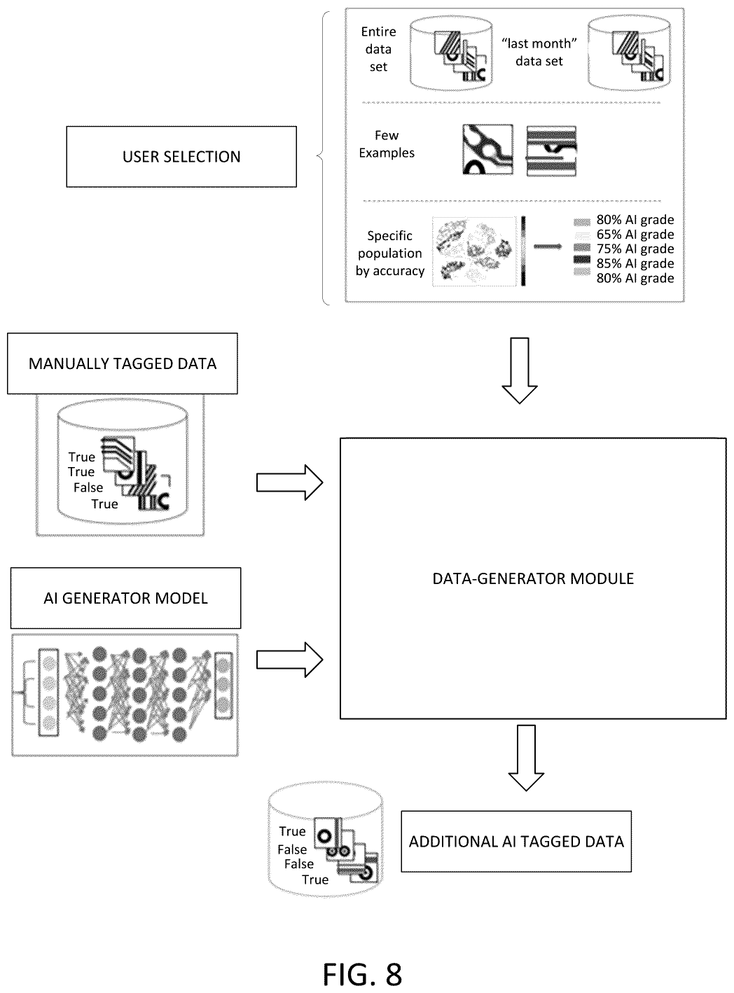

FIG. 8 is data flow diagram illustrating the computer-implemented process of generating additional AI-tagged data executed by the by the electronic data storage unit 215 and the processor 214. As shown in FIG. 8, a user selection is input into the data-generator module along with the manually tagged data and the AI generator model, which is configured to output additional AI-tagged data based on a subset of the manually tagged data according to the user selection. The user selection may be, for example, a selection based on a specific time period of when the images of the workpiece were captured, one or more specific examples of a particular type of defect, or a specific population of data of the manually tagged data having a specific accuracy grade or accuracy threshold. The computer-implemented process of retraining the AI inference model executed by the by the electronic data storage unit 215 and the processor 214 is similar to the process shown in FIG. 6, except the additional AI-tagged data is added to the combined dataset which is input into the AI training module to train the AI inference model.

The program instructions may be implemented in any of various ways, including procedure-based techniques, component-based techniques, and/or object-oriented techniques, among others. For example, the program instructions may be implemented using ActiveX controls, C++ objects or code, JavaBeans, Microsoft Foundation Classes (MFC), Streaming SIMD Extension (SSE), Python scripts, or other technologies or methodologies, as desired.

Each of the steps of the method may be performed as described herein. The methods also may include any other step(s) that can be performed by the processor and/or computer subsystem(s) or system(s) described herein. The steps can be performed by one or more computer systems, which may be configured according to any of the embodiments described herein. In addition, the methods described above may be performed by any of the system embodiments described herein.

The AI interference model and the AI generator model described herein may be deep learning models. Rooted in neural network technology, deep learning is a probabilistic graph model with many neuron layers, commonly known as a deep architecture. Deep learning technology processes the information such as image, text, voice, and so on in a hierarchical manner. In using deep learning in the present disclosure, feature extraction is accomplished automatically using learning from data. For example, defects can be classified, sorted, or binned using the deep learning classification module based on the one or more extracted features.

Generally speaking, deep learning (also known as deep structured learning, hierarchical learning or deep machine learning) is a branch of machine learning based on a set of algorithms that attempt to model high level abstractions in data. In a simple case, there may be two sets of neurons: ones that receive an input signal and ones that send an output signal. When the input layer receives an input, it passes on a modified version of the input to the next layer. In a deep network, there are many layers between the input and output, allowing the algorithm to use multiple processing layers, composed of multiple linear and non-linear transformations.

Deep learning is part of a broader family of machine learning methods based on learning representations of data. An observation (e.g., a feature to be extracted for reference) can be represented in many ways such as a vector of intensity values per pixel or in a more abstract way like a set of edges, regions of particular shape, etc. Some representations are better than others at simplifying the learning task (e.g., face recognition or facial expression recognition). Deep learning can provide efficient algorithms for unsupervised or semi-supervised feature learning and hierarchical feature extraction.

In an embodiment, the deep learning models of the AI interference model and the AI generator model may be configured as neural networks. In a further embodiment, the deep learning models may be deep neural networks with a set of weights that model the world according to the data that it has been fed to train it. Neural networks can be generally defined as a computational approach based on a relatively large collection of neural units loosely modeling the way a biological brain solves problems with relatively large clusters of biological neurons connected by axons. Each neural unit is connected with many others, and links can be enforcing or inhibitory in their effect on the activation state of connected neural units. These systems are self-learning and trained rather than explicitly programmed and excel in areas where the solution or feature detection is difficult to express in a traditional computer program.

Neural networks typically include multiple layers, and the signal path traverses from front to back. The goal of the neural network is to solve problems in the same way that the human brain would, although several neural networks are much more abstract. Modern neural network projects typically work with a few thousand to a few million neural units and millions of connections. The neural network may have any suitable architecture and/or configuration known in the art.

Generative adversarial networks (GANs) provide generative modeling using deep learning methods, such as convolutional neural networks. Generative modeling is an unsupervised learning task in machine learning that involves automatically discovering and learning the regularities or patterns in input data so that the model can be used to generate or output new examples that plausibly could have been determined from the original dataset.

GANs train a generative model by framing the problem as a supervised learning problem with two sub-models. First, there is a generator model that is trained to generate new examples. Second, there is a discriminator model that tries to classify examples as either real (from the domain) or fake (generated). The two models are trained together in a zero-sum game (i.e., adversarial) until the discriminator model is fooled enough that the generator model is generating plausible examples.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
a light source configured to generate a beam of light;
a stage configured to hold a workpiece in a path of the beam of light;
a detector configured to capture an image of the workpiece based on the beam of light reflected from the workpiece;
a processor in electronic communication with the detector, wherein the processor is configured to inspect the image of the workpiece received from the detector using an artificial intelligence (AI) inference model that is trained using a combined dataset of manually tagged data and AI-tagged data; and
an electronic data storage unit in electronic communication with the processor, wherein the AI inference model is stored on the electronic data storage unit.

2. The system of claim 1, wherein the processor is further configured to:
receive manually tagged data;
generate AI-tagged data based on the manually tagged data using an AI generator model, wherein the AI generator model is stored on the electronic data storage unit;
combine the manually tagged data and the AI-tagged data to produce the combined dataset; and
train the AI inference model using the combined dataset.

3. The system of claim 2, wherein the manually tagged data comprises data having a timestamp within a defined time period.

4. The system of claim 2, wherein the processor is further configured to:
determine a subset of the manually tagged data;
generate additional AI-tagged data based on the subset of the manually tagged data using the AI generator model;
combine the combined dataset and the additional AI-tagged data to produce an extended training dataset; and
retrain the AI inference model using the extended training dataset.

5. The system of claim 4, wherein the processor is configured to determine the subset of the manually tagged data according to a type of defect in the workpiece, in response to receiving a user selection of the type of defect in the workpiece.

6. The system of claim 5, wherein the processor is further configured to determine the subset of the manually tagged data according to the type of defect in the workpiece having an accuracy that is less than an accuracy threshold, in response to receiving a user selection of the accuracy threshold.

7. The system of claim 1, wherein the manually tagged data and the AI-tagged data are tagged according to a binary classification based on presence of a defect in the workpiece.

8. The system of claim 1, wherein the manually tagged data and the AI-tagged data are tagged according to a plural classification based on identification of one of a plurality of types of defects in the workpiece.

9. A method comprising:
receiving, at a processor, an image of a workpiece; and
inspecting the image using an artificial intelligence (AI) inference model that is trained using a combined dataset of manually tagged data and AI-generated data.

10. The method of claim 9, further comprising:
receiving manually tagged data;
generating AI-tagged data based on the manually tagged data using an AI generator model;
combining the manually tagged data and the AI-tagged data to produce the combined dataset; and
training the AI inference model using the combined dataset.

11. The method of claim 10, wherein the manually tagged data comprises data having a timestamp within a defined time period.

12. The method of claim 10, further comprising:
determining a subset of the manually tagged data;
generating additional AI-tagged data based on the subset of the manually tagged data using the AI generator model;
combining the combined dataset and the additional AI-tagged data to produce an extended training dataset; and
retraining the AI inference model using the extended training dataset.

13. The method of claim 12, wherein determining the subset of the manually tagged data comprises:
receiving a user selection of a type of defect in the workpiece; and
determining the subset of the manually tagged data according to the type of defect in the workpiece.

14. The method of claim 13, wherein determining the subset of the manually tagged data further comprises:
receiving a user selection of an accuracy threshold; and
determining the subset of the manually tagged data according to the type of defect in the workpiece having an accuracy that is less than the accuracy threshold.

15. A non-transitory computer-readable storage medium comprising one or more programs which, when executed by a processor, cause the processor to:
receive an image of a workpiece; and
inspect the image using an artificial intelligence (AI) inference model that is trained using a combined dataset of manually tagged data and AI-generated data.

16. The non-transitory computer-readable storage medium of claim 15, wherein the processor is further caused to:
receive manually tagged data;
generate AI-tagged data based on the manually tagged data using an AI generator model, wherein the AI generator model is stored on the electronic storage unit;
combine the manually tagged data and the AI-tagged data to produce the combined dataset; and
train the AI inference model using the combined dataset.

17. The non-transitory computer-readable storage medium of claim 16, wherein the manually tagged data comprises data having a timestamp within a defined time period.

18. The non-transitory computer-readable storage medium of claim 16, wherein the processor is further caused to:
determine a subset of the manually tagged data;
generate additional AI-tagged data based on the subset of the manually tagged data using the AI generator model;
combine the manually tagged data and the additional AI-tagged data to produce an extended training dataset; and
retrain the AI inference model using the extended training dataset.

19. The non-transitory computer-readable storage medium of claim 18, wherein the processor is further caused to:
receive a user selection of a type of defect in the workpiece; and
determine the subset of the manually tagged data according to the type of defect in the workpiece.

20. The non-transitory computer-readable storage medium of claim 19, wherein the processor is further caused to:
receive a user selection of an accuracy threshold; and
determine the subset of the manually tagged data according to the type of defect in the workpiece having an accuracy that is less than the accuracy threshold.
